(19) United States
(12) Patent Application Publication
(10) Pub. No.: US 2026/0293992 A1
(43) Pub. Date: Oct. 1, 2026

(54) AEROSOL-GENERATING DEVICE AND ASSOCIATED SYSTEM AND METHOD

(71) Applicant: Philip Morris Products S.A., Neuchatel (CH)

(72) Inventors: Oleg MIRONOV, Cudrefin (CH); Johannes Petrus Maria PIJNENBURG, Neuchâtel (CH); Andreas Michael ROSSOLL, Le Mont-sur-Lausanne (CH); Julien VIDAL, Peseux (CH)

(73) Assignee: Philip Morris Products S.A., Neuchatel (CH)

(21) Appl. No.: 19/479,579

(22) PCT Filed: Apr. 29, 2024
(86) PCT No.: PCT/EP2024/061809

§ 371 Date: Oct. 28, 2025

(30) Foreign Application Priority Data
May 2, 2023 (EP) 23171169.8

(51) Int. Cl. A24F 40/465; A24F 40/53; A24F 40/57; H05B 3/02; H05B 6/10

(52) U.S. Cl. CPC A24F 40/465; A24F 40/53; A24F 40/57; H05B 3/02; H05B 6/10

(57) ABSTRACT

An aerosol-generating device is provided, including: a chamber configured to receive at least a portion of an aerosol-generating article including an aerosol-forming substrate; an electrically resistive heater at least partially surrounding or defining the chamber and configured to provide a heating zone in the chamber, and an inductor coil at least partially surrounding the electrically resistive heater and configured to generate an alternating magnetic field in the chamber when the inductor coil is supplied with an alternating current.

The present disclosure relates to an aerosol-generating device. The present disclosure also relates to an aerosol-generating system comprising the aerosol-generating device and a method of controlling the aerosol-generating device.

Some known aerosol-generating systems comprise an aerosol-generating device and an aerosol-generating article comprising an aerosol-forming substrate. In use, the aerosol-generating device heats the aerosol-forming substrate of the aerosol-generating article to form an aerosol.

Some known aerosol-generating devices comprise an internal heater for heating the aerosol-forming substrate from within, such as a heating blade which, in use, penetrates and heats the aerosol-forming substrate from within. However, using an internal heater to heat an outer portion of the aerosol-forming substrate sufficiently to form an aerosol may require heating the internal heater to a sufficiently high temperature that there is a risk of the internal heater overheating or burning an inner portion of the aerosol-forming substrate close to the internal heater. Thus, the use of an internal heater typically leads to an outer portion of the aerosol-forming substrate, furthest from the internal heater during use, not being heated to a sufficiently high temperature to form an aerosol. This means that the outer portion of the aerosol-forming substrate is typically wasted.

Some known aerosol-generating devices comprise an external heater for heating the aerosol-forming substrate from outside the aerosol-forming substrate, such as a tubular heating element which, in use, receives a portion of the aerosol-generating article and heats the aerosol-forming substrate from the outside. However, using an external heater to heat an inner portion of the aerosol-forming substrate sufficiently to form an aerosol may require heating the heater to a sufficiently high temperature that there is a risk of the external heater overheating or burning the outer portion of the aerosol-forming substrate close to the heater. Thus, the use of an external heater typically leads to an inner portion of the aerosol-forming substrate, furthest from the heater during use, not being heated to a sufficiently high temperature to form an aerosol. This means that the inner portion of the aerosol-forming substrate is typically wasted.

It is an aim of the present invention to provide an improved aerosol-generating device, system, and control or heating method.

According to the present disclosure, there is provided an aerosol-generating device. The aerosol-generating device may comprise a chamber or cavity for receiving at least a portion of an aerosol-generating article. The aerosol-generating article may comprise an aerosol-forming substrate. The aerosol-generating device may comprise a heater. The heater may at least partially surround or define the chamber or cavity. The heater may be configured to provide a heating zone in the chamber. The aerosol-generating device may comprise an inductor coil configured to generate an alternating magnetic field in the chamber when the inductor coil is supplied with an alternating current.

Thus, according to a first aspect of the present disclosure, there is provided an aerosol-generating device comprising: a chamber for receiving at least a portion of an aerosol-generating article comprising an aerosol-forming substrate; a heater at least partially surrounding or defining the chamber and configured to provide a heating zone in the chamber; and an inductor coil configured to generate an alternating magnetic field in the chamber when the inductor coil is supplied with an alternating current. The chamber may be, or may be referred to as, a cavity.

Advantageously, the aerosol-generating device comprises a heater at least partially surrounding or defining the chamber, as well as an inductor coil configured to generate an alternating magnetic field in the chamber. An aerosol-generating article may be removably receivable in the chamber. In use, the heater may heat an aerosol-forming substrate of the received aerosol-generating article from the outside, and the inductor coil may inductively heat a susceptor located inside the aerosol-forming substrate. Thus, advantageously, the aerosol-generating device may allow heating of the aerosol-forming substrate simultaneously, partially simultaneously, or sequentially from the outside and from the inside. This may advantageously result in the ability to heat both an inner portion and an outer portion of the aerosol-forming substrate sufficiently to form an aerosol whilst reducing a risk of a heater overheating or a portion of the aerosol-forming substrate burning.

For the avoidance of doubt, references herein to the heater being configured to provide a heating zone should not be interpreted to mean that the heating zone is heated exclusively by the heater in use. Other components, such as the susceptor discussed later, may provide for heat to the heating zone in use.

References herein to the system, the device, the article, and the substrate may refer to the aerosol-generating system, the aerosol-generating device, the aerosol-generating article, and the aerosol-forming substrate respectively.

The aerosol-generating system may comprise a susceptor. Optionally, the article comprises the susceptor. In this case, the susceptor may be in the aerosol-forming substrate of the article. Optionally, the susceptor is separate to the device and the article. In this case, the susceptor may be insertable into the aerosol-forming substrate prior to use or may be attachable to the device prior to use. Optionally, the device comprises the susceptor. In this case, the susceptor may be configured to penetrate an article received in the chamber.

The susceptor may be shaped as a pin, blade or rod. The chamber may comprise an open first end, optionally through which at least a portion of an aerosol-generating article may be inserted into the chamber. Optionally, the chamber comprises an at least partially closed second end, or at least partially closed base, optionally opposite the open first end. The susceptor may project into the chamber, for example from the base towards the open end.

The susceptor may be attachable to, and detachable from, the aerosol-generating device, for example using a clip, a screw thread, a snap-fit, or any other suitable attaching means. The susceptor may be attachable to, and detachable from, the chamber, for example the base of the chamber, for example to project into the chamber, optionally from the base towards the open end. Advantageously, this may allow removal of the susceptor for cleaning or disposal.

The aerosol-generating system may comprise a plurality of susceptors. The aerosol-generating article may comprise a plurality of susceptors. The aerosol-generating device may comprise a plurality of susceptors. As the skilled person would understand after reading this disclosure, features described in relation to a, or the, susceptor may be applicable to one or more or each of the plurality of susceptors. Thus, references herein to a, or the, susceptor may be considered references to the one or more susceptors.

In use, when supplied with an alternating current, the inductor coil may generate an alternating magnetic field in the chamber. The alternating current supplied to the inductor coil may be a high frequency alternating current. For the purpose of this disclosure, the term “high frequency” may denote a frequency ranging from 1 Megahertz to 30 Megahertz, preferably 1 Megahertz to 10 Megahertz, more preferably 5 Megahertz to 7 Megahertz. In use, the alternating magnetic field may cause eddy currents and hysteresis losses in a susceptor located in the chamber, and thus cause heating of the susceptor. Thus, in use, the inductor coil may inductively heat the susceptor. In use, the susceptor may then heat the aerosol-forming substrate, for example from within the aerosol-forming substrate. This may be the case regardless of whether the susceptor is part of the article and located within the aerosol-forming substrate, or the susceptor is part of the device and penetrates the aerosol-forming substrate when the article is received in the chamber.

The susceptor, which may also be referred to as the susceptor element, may comprise or consist of one or more susceptor materials.

Suitable susceptor materials may include but are not limited to: carbon, carbon-based materials, graphene, graphite, expanded graphite, molybdenum, silicon carbide, stainless steels, niobium, aluminium, nickel, nickel-containing compounds, titanium, and composites of metallic materials. Suitable susceptor materials may comprise a ferromagnetic material, for example, ferritic iron, a ferromagnetic alloy, such as ferromagnetic steel or stainless steel, ferromagnetic particles, and ferrite. A susceptor material may comprise more than 5 percent, preferably more than 20 percent, more preferably more than 50 percent or more than 90 percent of ferromagnetic or paramagnetic materials. Preferred susceptor materials may comprise a metal, metal alloy or carbon.

Optionally, the device comprises at least one power supply. Any references here to the power supply should be interpreted as references to the at least one power supply. Optionally, the device comprises a controller. Optionally, the controller is configured to independently control a supply of power from the at least one power supply to the heater and a supply of power from the at least one power supply to the inductor coil. Advantageously, independently controlling a supply of power to the heater and a supply of power to the inductor coil may allow independent control of a temperature of the heater and a temperature of a susceptor in the chamber being inductively heated by the alternating magnetic field generated by the inductor coil.

Optionally, the device comprises a first power supply and a second power supply different to the first power supply. Optionally, the controller is configured to independently control a supply of power from the first power supply to the heater and a supply of power from the second power supply to the inductor coil. Advantageously, use of first and second power supplies may simplify the independent control of the supplies of power to the heater and the inductor coil.

Optionally, the controller is configured to identify at least one maintenance phase during use of the device. The or each maintenance phase may correspond to or include a phase during which a user is not puffing on the device or an article received in the chamber. Optionally, the controller is configured to identify at least one puffing phase during use of the device. The or each puffing phase may correspond to or include a phase during which a user is puffing on the device or an article received in the chamber. Advantageously, as explored in more detail later, identifying maintenance and puffing phases may allow optimising control of supplies of power to the heater and the inductor coil during these phases. A puffing phase may be referred to as an inhalation phase.

A usage session of the device may comprise a plurality of maintenance phases and a plurality of puffing phases. Optional features described herein for a maintenance phase may apply to each of a plurality of maintenance phases. Optional features described herein for a puffing phase may apply to each of a plurality of puffing phases.

Optionally, the controller is configured to control a supply of power from the at least one power supply to one or both of the heater and the inductor coil during the maintenance phase.

During the maintenance phase, the controller may be configured to control a supply of power from the at least one power supply to one or both of the inductor coil and the heater to maintain a temperature of the heating zone below an aerosolisation temperature of the aerosol-forming substrate. Advantageously, this may preserve the aerosol-forming substrate for other phases where aerosol formation is desired.

References herein to a temperature of the heating zone may refer to a temperature at any point in the heating zone, or to a temperature at a roughly central point in the heating zone, or to an average temperature in the heating zone, or to a highest temperature at any point in the heating zone.

Optionally, during the maintenance phase, the controller is configured to control a supply of power from the at least one power supply to one or both of the inductor coil and the heater to maintain a temperature of the heating zone within a heating zone maintenance temperature range. Optionally, the heating zone maintenance temperature range has an upper limit which is less than a temperature required for the aerosol-forming substrate to form an aerosol. Optionally, the heating zone maintenance temperature range has an upper limit of no more than 250, 200, or 170 degrees Celsius. Optionally, the heating zone maintenance temperature range has a lower limit of at least 50, 100, or 140 degrees Celsius. Optionally, the heating zone maintenance temperature range is between 50 and 250, 50 and 200, 50 and 170, 100 and 250, 100 and 200, 100 and 170, 140 and 250, 140 and 200, or 140 and 170 degrees Celsius. Advantageously, such temperatures may be sufficiently low so as to avoid forming much or any aerosol from the aerosol-forming material of the aerosol-forming substrate but sufficiently high so as to allow the aerosol-forming substrate to be further heated, for example to rapidly or instantaneously exceed an aerosol-forming temperature for the aerosol-forming material, to produce an aerosol quickly when desired. As the skilled person would understand after reading this disclosure, references herein to heating the aerosol-forming substrate to form an aerosol may be considered references to heating aerosol-forming material of the aerosol-forming substrate to form an aerosol. It is not essential that all components or materials of the aerosol-forming substrate are heatable to form an aerosol. Indeed, some components or materials of the aerosol-forming substrate may, and others may not, be heated to form an aerosol in use.

Optionally, during the maintenance phase, the controller is configured to control a supply of power from the at least one power supply to the heater to maintain a temperature of the heater within a heater maintenance temperature range. The optional features discussed above in relation to the heating zone maintenance temperature range are equally applicable to the heater maintenance temperature range. Thus, the heater maintenance temperature range may have one or more of: an upper limit which is less than a temperature required for the heater to heat the aerosol-forming material of the aerosol-forming substrate sufficiently to form an aerosol; an upper limit of no more than 250, 200, or 170 degrees Celsius; a lower limit of at least 50, 100, or 140 degrees Celsius. The heater maintenance temperature range may be between 50 and 250, 50 and 200, 50 and 170, 100 and 250, 100 and 200, 100 and 170, 140 and 250, 140 and 200, or 140 and 170 degrees Celsius. Advantageously, such temperatures may be sufficiently low so as to avoid forming much or any aerosol formed from the aerosol-forming material of the aerosol-forming substrate but sufficiently high so as to allow the aerosol-forming substrate to be further heated to produce an aerosol quickly when desired.

Optionally, during the maintenance phase, the controller is configured to supply no power from the at least one power supply to the inductor coil. Advantageously, this may conserve power during the maintenance phase when heating of the susceptor to heat the aerosol-forming substrate to form aerosol is not required. For the avoidance of doubt, references to controlling a supply of power to the inductor coil may include supplying no power to the inductor coil.

Alternatively, during the maintenance phase, the controller may be configured to control a supply of power from the at least one power supply to the inductor coil to maintain a temperature of a susceptor in the chamber within a susceptor maintenance temperature range. The optional features discussed above in relation to the heating zone maintenance temperature range are equally applicable to the susceptor maintenance temperature range. Thus, the susceptor maintenance temperature range may have one or more of: an upper limit which is less than a temperature required for the susceptor to heat the aerosol-forming substrate sufficiently to form an aerosol; an upper limit of no more than 250, 200, or 170 degrees Celsius; a lower limit of at least 50, 100, or 140 degrees Celsius. The susceptor maintenance temperature range may be between 50 and 250, 50 and 200, 50 and 170, 100 and 250, 100 and 200, 100 and 170, 140 and 250, 140 and 200, or 140 and 170 degrees Celsius. Advantageously, such temperatures may be sufficiently low so as to avoid forming much or any aerosol from the aerosol-forming material of the aerosol-forming substrate but sufficiently high so as to allow the aerosol-forming substrate to be further heated to produce an aerosol quickly when desired.

Optionally, the device is configured to detect one or more user puffs, for example during a usage session. Such puffs may be puffs taken on the device or on an article received in the chamber. The device may comprise a puff detection mechanism for detecting the one or more user puffs. The puff detection mechanism may comprise at least a portion of, or may utilise, the controller. Advantageously, this may allow controlling heating based on when the user is puffing.

The terms “puff”, “user puff”, “puff taken” and the like may all be used herein synonymously. These terms may all be used to refer to a user inhaling on the device or article. Each reference to a puff may be considered to be a reference to a puff during a usage session.

The maintenance phase may be a period during which a user is not puffing on the device or article. The maintenance phase may be a period where the device or system is in an idle state, optionally ready for a puff or inhalation to take place. The puffing phase may be a period during which a user is puffing on the system, for example the device or article.

Optionally, the device, for example the puff detection mechanism of the device, comprises a pressure sensor. Optionally, the device, for example the puff detection mechanism of the device, comprises a flow restrictor such as a venturi tube. Optionally, the pressure sensor is configured to sense a pressure of an air flow through the flow restrictor. The device may comprise a device air inlet. The device may comprise a device air outlet. The device may comprise a device air flow path. The device air flow path may connect the device air inlet to the device air outlet. In use, in response to a user puffing on the device or an article received in the chamber of the device, air may flow through the device air inlet, through the device air flow path, then through the device air outlet. The flow restrictor may be positioned in the device air flow path. The flow restrictor may comprise a restriction in a cross-sectional area of the device air flow path for example as compared to a cross-sectional area of the air inlet. Advantageously, the flow restrictor may result in an air flow through the device air flow path increasing in speed as the air flow travels through the flow restrictor. Thus, advantageously, a larger pressure drop may be observed within the flow restrictor for a given puff. This may advantageously allow a pressure sensor configured to detect a pressure in the flow restrictor to detect weaker puffs and may allow the pressure sensor to more precisely determine an air flow rate through the device.

Optionally, the puff detection mechanism is configured to detect puffs by monitoring changes in one or both of: a power supplied to at least one puff detection heater; and a temperature of at least one puff detection heater. The at least one puff detection heater may be or comprise one or both of the internal heater and the external heater. The at least one puff detection heater may be in the air flow path. In use, during a puff, air may flow past the at least one puff detection heater. This may act to cool the at least one puff detection heater. This may mean that the temperature of the at least one puff detection heater decreases, or that an increase in power supplied to the at least one puff detection heater is required to maintain its temperature. This decrease in temperature, or increase in power supplied, may indicate that a user is puffing on the system and thus may allow the puff detection mechanism to detect the puff. This way to detect a puff is explained in more detail in, for example, WO2013098397, the contents of which is incorporated herein.

Optionally, the device, for example the puff detection mechanism of the device, is configured to detect a start of a or each user puff taken during the usage session. Optionally, the device, for example the puff detection mechanism of the device, is configured to detect an end of a or each user puff taken during the usage session. Advantageously, being able to detect a start and an end of a user puff may allow the device to accurately switch between the maintenance phase and the puffing phase depending on when the user is puffing.

Optionally, the device, for example the puff detection mechanism of the device, is configured to determine or estimate a time duration of a or each puff taken during a usage session. Optionally, the device, for example the puff detection mechanism of the device, is configured to determine or estimate a time duration of a puff so far. This may be done by determining or estimating the time duration of the puff so far continuously or at one or more time points, for example time points at time periods after a start of the puff.

Optionally, the device, for example the puff detection mechanism of the device, is configured to determine or estimate a volume of at least a portion, for example the total volume from start to end, of a or each puff taken during a usage session. For example, for a or each puff, the device, for example the puff detection mechanism of the device, may be configured to determine the volume of the puff so far continuously or at one or more time points, for example time points at time periods after a start of the puff. As the skilled person would understand after reading this disclosure, the volume of the puff may refer to the volume of the air flow through the device as a result of a user puffing on the device or article.

Optionally, the device, for example the puff detection mechanism of the device, is configured to measure, determine or estimate one or more instantaneous flow rates of an air flow resulting from a or each puff taken during a usage session. For example, for a or each puff, the device, for example the puff detection mechanism of the device, may be configured to determine the flow rate of an air flow resulting from the puff continuously or at one or more time points, for example time points at time periods after a start of the puff. Herein, unless otherwise specified, the term “flow rate” may refer to a flow speed measurable in metres per second or a volumetric flow rate measurable in metres cubed per second. Features described in relation to a flow rate may apply to one or both of flow speed measurable in metres per second and volumetric flow rate measurable in metres cubed per second.

The device or puff detection mechanism may comprise a flow meter. The flow meter may be configured to measure, determine or estimate one or more instantaneous flow rates of an air flow resulting from a or each puff taken during a usage session. As stated above, flow rate may refer to one or both of flow speed measurable in metres per second and volumetric flow rate measurable in metres cubed per second.

The flow meter may be or comprise any suitable type of flow meter, such as a turbine flow meter. One example of a turbine flow meter is shown in WO2022184510. Such a turbine flow meter, or any other suitable flow meter, could be used in the present device and coupled to the controller to provide the controller with an estimate of one or both of a flow speed measurable in metres per second and a volumetric flow rate measurable in metres cubed per second. For a turbine flow meter, this could be based on an angular speed, or revolution rate, of the turbine. As another example, the flow meter may comprise a or the pressure sensor. The pressure sensor may be coupled to the controller and configured to provide the controller with an estimate of one or both of a flow speed measurable in metres per second and a volumetric flow rate measurable in metres cubed per second based on sensed pressure. Air flow meters are commercially available and, after reading the present disclosure, the skilled person would be able to implement a suitable flow meter into the device.

Optionally, the device, for example the puff detection mechanism of the device, is configured to determine or estimate an instantaneous rate of change of flow rate of an air flow resulting from a or each puff taken during a usage session. For example, for a or each puff, the device, for example the puff detection mechanism of the device, may be configured to determine the rate of change of flow rate of an air flow resulting from the puff continuously or at one or more time points, for example time points at time periods after a start of the puff.

Optionally, the controller is configured to one or both of end the maintenance phase and initiate the puffing phase when a puff or a start of a puff is detected. Optionally, the controller is configured to adjust, for example increase, one or both of a supply of power to the heater and a supply of power to the inductor coil when a puff or a start of a puff is detected. Advantageously, this may allow the device to quickly respond to a user puff and generate an aerosol accordingly.

Optionally, the controller is configured to one or both of end the puffing phase and initiate the maintenance phase when an end of a puff is detected. Optionally, the controller is configured to adjust, for example decrease, one or both of a supply of power to the heater and a supply of power to the inductor coil when an end of a puff is detected. Advantageously, this may allow the device to quickly respond to a user puff ending and stop generating an aerosol accordingly. Reverting to the maintenance phase may advantageously allow the device to keep the aerosol-forming substrate warm so as to reduce a time required to generate an aerosol in response to detecting a start of the next puff.

Optionally, in response to detection of a puff, the controller is configured to adjust, for example increase, a supply of power from the at least one power supply to one or both of the inductor coil and the heater to adjust, for example increase, a temperature of the heating zone, for example to above an aerosolisation temperature of an aerosol-forming material of an aerosol-forming substrate or to within a heating zone puffing temperature range. Optionally, the heating zone puffing temperature range has a lower limit of at least 200, 250, or 300 degrees Celsius. Optionally, the heating zone puffing temperature range has an upper limit of no more than 800, 650, or 500 degrees Celsius. Optionally, the heating zone puffing temperature range is between 200 and 800, or 200 and 650, or 200 and 500, or 250 and 800, or 250 and 650, or 250 and 500, or 300 and 800, or 300 and 650, or 300 and 500 degrees Celsius. Advantageously, such an increase in temperature of the heating zone, which may occur during the puffing phase, may result in an aerosol-forming material of the aerosol-forming substrate in the heating zone being heated to form a desirable quantity of an aerosol of a desirable composition.

Optionally, in response to detection of a puff, the controller is configured to adjust, for example increase, a supply of power from the at least one power supply to the inductor coil. Optionally, in response to the device, for example the puff detection mechanism of the device, detecting a puff, the controller is configured to adjust, for example increase, a supply of power from the at least one power supply to the inductor coil to increase a temperature of the susceptor, for example to a susceptor puffing temperature range. The susceptor puffing temperature range may have a lower limit above an aerosolisation temperature of an aerosol-forming material of an aerosol-forming substrate. The susceptor puffing temperature range may have a lower limit of at least 200, 250, or 300 degrees Celsius. The susceptor puffing temperature range may have an upper limit of no more than 800, 650, or 500 degrees Celsius. The susceptor puffing temperature range may be between 200 and 800, or 200 and 650, or 200 and 500, or 250 and 800, or 250 and 650, or 250 and 500, or 300 and 800, or 300 and 650, or 300 and 500 degrees Celsius. The temperature of the susceptor may be increased to a sufficiently high temperature for the susceptor to heat the aerosol-forming substrate to form an aerosol.

Optionally, the controller is configured to not adjust a supply of power from the at least one power supply to the heater in response to detection of a puff. Optionally, in response to detection of a puff, the controller is configured to control a supply of power from the at least one power supply to the heater in an identical manner to during the maintenance phase. Optionally, in response to detection of a puff, the controller is configured to control a supply of power from the at least one power supply to the heater to maintain a temperature of the heater within a heater puffing temperature range. Optionally, the heater puffing temperature range is identical to the heater maintenance temperature range. Optionally, the heater puffing temperature range has an upper limit of no more than an aerosolisation temperature of the aerosol-forming material of an aerosol-forming substrate, or than 250, 200, or 170 degrees Celsius. Optionally, the heater puffing temperature range has a lower limit of at least 50, 100, or 140 degrees Celsius. Optionally, the heater puffing temperature range between 50 and 250, 50 and 200, 50 and 170, 100 and 250, 100 and 200, 100 and 170, 140 and 250, 140 and 200, 140 and 170 degrees Celsius. Advantageously, this may conserve power as it may be the susceptor, rather than the heater, which is predominantly responsible for aerosol generation during the puffing phase. It may be preferable for the susceptor, rather than the heater, to have this responsibility since it may be more likely that the susceptor is in more intimate thermal contact with the aerosol-forming substrate and thus be able to generate the aerosol quickly and efficiently. It may be preferable to heat the susceptor, rather than the heater, when quick heating of the aerosol-forming substrate or heating zone is required, as the susceptor may be able to heat the aerosol-forming substrate or heating zone more quickly than the heater.

As an alternative, the controller may be configured to adjust, for example increase, a supply of power from the at least one power supply to the heater in response to detection of a puff. In this case, the heater puffing temperature range may have one or more of: a lower limit above an aerosolisation temperature of an aerosol-forming substrate; a lower limit of at least 200, 250, or 300 degrees Celsius; an upper limit of no more than 800, 650, or 500 degrees Celsius. The heater puffing temperature range may be between 200 and 800, or 200 and 650, or 200 and 500, or 250 and 800, or 250 and 650, or 250 and 500, or 300 and 800, or 300 and 650, or 300 and 500 degrees Celsius. Advantageously, in this case, more aerosol may be generated more quickly during the puffing phase compared with if the heater were not heated as much during the puffing phase.

The controller may be configured to adjust, for example increase, one or both of a supply of power to the heater and a supply of power to the inductor coil based on the device detecting, determining or estimating any one or more of the following:
a start of a puff or inhalation;
a time duration of a puff so far reaching, for example increasing to above, a first threshold (for example to ensure that the detected air flow is a puff and not a short-lived, non-puff related air flow such as an air flow caused by brief motion of the device or wind);
a volume of a puff so far reaching, for example increasing to above, a first threshold (for example to ensure that the detected air flow is a puff and not a small volume, non-puff-related air flow);
an instantaneous flow rate of an air flow resulting from the puff reaching, for example increasing to above, a first threshold (for example to ensure that the detected air flow is a puff and not a small, non-puff-related air flow);
an instantaneous flow rate of an air flow resulting from the puff staying above a first threshold for at least a first time period (for example to ensure that the detected air flow is a puff and not a small and short-lived, non-puff-related air flow);
an instantaneous rate of change of flow rate of an air flow resulting from the puff reaching, for example increasing to above, a first threshold (for example indicating that the detected air flow is increasing at a sufficient rate to indicate that it is a puff and not a small, non-puff-related air flow);
an instantaneous rate of change of flow rate of an air flow resulting from the puff staying above a first threshold for at least a first time period (for example indicating that the detected air flow has been increasing at a sufficient rate for a sufficient length of time to indicate that it is a puff and not a small, non-puff-related air flow);
a temperature of the heating zone or the heater decreasing to below a lower threshold (for example indicating that the flow rate has increased, so a cooling effect of the air flow has increased resulting in a temperature of the heating zone or heater decreasing, thus indicating that a puff is being taken, for example as explained in WO2013098397, the contents of which is incorporated herein); and
a temperature of the heating zone or the heater staying below a lower threshold for at least a first time period (for example indicating that the flow rate has increased, so a cooling effect of the air flow has increased resulting in a temperature of the heating zone or heater decreasing, thus indicating that a puff is being taken).

One or both of ending the maintenance phase and starting the puffing phase may occur in response to, or an amount of time after, the device detecting, determining or estimating any one or more of the options in the bullet points in the preceding paragraph.

The controller may be configured to adjust, for example decrease, one or both of a supply of power to the heater and a supply of power to the inductor coil based on the device detecting, determining or estimating any one or more of the following:
an end of a puff;
a time duration of a puff so far reaching, for example increasing to above, a second threshold (for example indicating that the puff is likely to end soon);
a volume of a puff so far reaching, for example increasing to above, a second threshold (for example indicating that the puff is likely to end soon);
an instantaneous flow rate of an air flow resulting from the puff reaching, for example decreasing to below, a second threshold (for example decreasing from above to below the second threshold indicating that the puff is likely to end soon);
an instantaneous flow rate of an air flow resulting from the puff staying below a second threshold for at least a second time period (for example indicating that the puff is likely to end soon);
an instantaneous rate of change of flow rate of an air flow resulting from the puff reaching, for example decreasing to below, a second, optionally negative, threshold (for example indicating that the flow rate is reducing sufficiently quickly to indicate that the puff is likely to end soon);
an instantaneous rate of change of flow rate of an air flow resulting from the puff staying below a second, optionally negative, threshold for at least a second time period (for example indicating that the flow rate has been reducing sufficiently quickly for a sufficient length of time to indicate that the puff is likely to end soon);
a temperature of the heating zone or the heater increasing above an upper threshold (for example indicating that the flow rate has reduced, so a cooling effect of the air flow has reduced to allow a temperature of the heating zone or heater to increase, thus indicating that the puff is likely to end soon); and
a temperature of the heating zone or the heater staying above an upper threshold for a time period (for example indicating that the flow rate has reduced, so a cooling effect of the air flow has reduced to allow a temperature of the heating zone or heater to increase, thus indicating that the puff is likely to end soon).

One or both of ending the puffing phase and starting the maintenance phase may occur in response to, or a predetermined amount of time after, the device detecting, determining or estimating any one or more of the options in the bullet points in the preceding paragraph.

Optionally, the heater is configured to heat one or both of the heating zone and an article received in the chamber. Optionally, the heater, for example an inner surface of the heater, is configured to contact the article when the article is at least partially received in the chamber. Advantageously, this may improve heat transfer from the heater to the article.

The heater may comprise a coating. The coating may be a protective coating. The coating may be a thermally conductive coating. The coating may be present on an inner surface of the heater. It may be the coating of the heater than contacts the article when the article is at least partially received in the chamber. Advantageously, the coating may protect the heater and may improve heat transfer from the heater to the article.

Optionally, the heater is substantially tubular. The chamber may be right cylindrical. Optionally, the heater defines or at least partially surrounds the chamber. Optionally the heater encircles the chamber. Advantageously, this may allow transfer of heat from the heater to the article from around an entire circumference of the article.

Optionally, the heater is or comprises an infrared-radiation based heating element, a photonic source, or an electrically resistive heating element. Preferably, the heater is or comprises an electrically resistive heater. The heater may comprise an electrically insulating substrate, for example a substantially tubular electrically insulating substrate, and an electrically resistive track on the electrically insulating substrate. The device may be configured to pass an electrical current through the electrically resistive track in use. This may electrically resistively heat or Joule-heat the electrically resistive track.

Suitable electrically insulating materials, for example for an electrically insulating substrate of an electrically resistive heater, may include one or more of: glass, ceramic, anodized metal, coated metal, and Polyimide. The ceramic may comprise mica, Alumina or Zirconia.

Suitable electrically resistive materials, for example for an electrically resistive track of an electrically resistive heater, may include one or more of: semiconductors such as doped ceramics, electrically resistive ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese- and iron-containing alloys, and super-alloys based on nickel, iron, cobalt, stainless steel, Timetal® and iron-manganese-aluminium based alloys. The electrically resistive track may comprise a heating wire or filament, for example a Ni—Cr (Nickel-Chromium), platinum, tungsten or alloy wire or filament.

Optionally, the heater, for example the electrically insulating substrate of the heater, comprises or consists of a thermally conductive material. Advantageously, this may make the temperature of the heater more uniform.

Optionally, the heater is substantially transparent to the alternating magnetic field generated by the inductor coil when the inductor coil is supplied with an alternating current. This property may be referred to as the heater being “substantially magnetically transparent”. This may be particularly advantageous where at least a part of the heater is between the inductor coil and the chamber, for example where the inductor coil surrounds the heater and the heater defines or surrounds the chamber.

The heater being substantially transparent to the alternating magnetic field generated by the inductor coil when the inductor coil is supplied with an alternating current may mean that, during use of the aerosol-generating device to generate an aerosol from an aerosol-forming substrate, the presence of the heater does not reduce heating, measured in Joules, of the susceptor by more than 10 or 5 percent compared to an identical device except for the omission of the heater. More specifically, the heater being substantially transparent to the alternating magnetic field generated by the inductor coil when the inductor coil is supplied with an alternating current may mean that, during use of the aerosol-generating device to generate an aerosol from an aerosol-forming substrate, for example under standard operational conditions, with an alternating current supplied to the inductor coil at a resonant (maximum susceptor-heating) frequency, the presence of the heater does not reduce heating, measured in Joules, of the susceptor by more than 10 or 5 percent (compared to an identical device except for the omission of the heater). Thus, advantageously, the transparency of the heater may correspond to minimal absorption by the heater of power supplied to the inductor coil.

During one or both of the maintenance phase and the puffing phase, the controller may be configured to supply an alternating current to the inductor coil. The frequency, or frequencies, of the alternating current supplied to the inductor coil may be selected such that the heater has no, or very little, influence on the alternating magnetic field generated by the inductor coil when supplied with the alternating current.

Optionally, the heater comprises, for example at least 90 percent by weight, or consists of substantially non-ferromagnetic materials. Optionally, the heater comprises, for example at least 90 percent by weight, or consists of substantially paramagnetic materials. Optionally, the heater comprises, for example at least 90 percent by weight, or consists of substantially diamagnetic materials. Optionally, the heater comprises, for example at least 90 percent by weight, or consists of substantially paramagnetic and diamagnetic materials. Optionally, the heater comprises, for example at least 90 percent by weight, austenitic steel such as austenitic stainless steel.

For the avoidance of doubt, the term “ferromagnetic” may refer to materials generally considered to exhibit strong attraction to magnets, the term “paramagnetic” may refer to materials generally considered to exhibit weak attraction to magnets, and the term “diamagnetic” may refer to materials generally considered to exhibit weak or strong repulsion to magnets. The terms paramagnetic and diamagnetic herein are intended to include materials which exhibit extremely weak, negligible, or even no observable interaction with magnetic fields, and thus include materials generally considered non-magnetic.

The heater may comprise, for example at least 90 percent by weight, or consist of materials that have a relative magnetic permeability close to 1, for example a maximum, relative magnetic permeability of no more than 2, 1.5, or 1.1. The heater may comprise, for example at least 90 percent by weight, or consist of materials that have a maximum, relative magnetic permeability of at least 0.99, 0.999, or 1. Relative magnetic permeability compares magnetic permeability of a material with that of free space. The “maximum relative magnetic permeability” is used since magnetic permeability varies with magnetic field strength. Any references to magnetic permeability herein are references to magnetic permeability at 20 degrees Celsius and a relative humidity of 50%. Advantageously, materials with relative magnetic permeabilities close to 1 may minimise the amount of power supplied to the inductor coil that is dissipated in the heater.

The heater may comprise, for example at least 90 percent by weight, or consist of materials that have an electrical conductivity of less than 0.8×10⁴ or 0.8×10³ or 0.8×10² Siemens per metre in at least one direction, for example in all directions, at 20 degrees Celsius and a relative humidity of 50%. Advantageously, materials with high electrical resistivities may minimise eddy currents induced due to the presence of an alternative magnetic field and thus minimise the amount of power supplied to the inductor coil that is dissipated in the heater.

Thus, a relative magnetic permeability close to 1 and a low electrical conductivity may work synergistically to minimise the amount of power supplied to the inductor coil that is dissipated in the heater. As such, it may be particularly advantageous for the heater to comprise, for example at least 90 percent by weight, or consist of materials having one or more or all of:
a maximum, relative magnetic permeability of no more than 2, 1.5, or 1.1;
a maximum, relative magnetic permeability of at least 0.99, 0.999, or 1; and
an electrical conductivity of less than 0.8×10⁴ or 0.8×10³ or 0.8×10² Siemens per metre in at least one direction, for example in all directions, at 20 degrees Celsius and a relative humidity of 50%. It may be particularly preferable for the heater to comprise, for example at least 90 percent by weight, or consist of materials having a maximum, relative magnetic permeability of between 0.99 and 2, preferably between 0.99 and 1.5, and optionally an electrical conductivity of less than 0.8×10⁴, preferably less than 0.8×10³, Siemens per metre in at least one direction, for example in all directions, at 20 degrees Celsius and a relative humidity of 50%. As set out above, advantageously, a relative magnetic permeability close to 1 and a low electrical conductivity may work synergistically to minimise the amount of power supplied to the inductor coil that is dissipated in the heater.

Optionally, the heater comprises a ceramic material. Where the heater comprises a ceramic material, the ceramic material may act as an electrically insulating substrate for an electrically resistive track, as discussed earlier.

Optionally, the heater comprises a polymer composite material. Optionally, the polymer composite material is substantially magnetically transparent, for example so as to provide a heater which is substantially magnetically transparent as discussed above. Optionally, the polymer composite material comprises a polymeric material, for example at least one polymeric material selected from the list: Polyether ether ketone (PEEK) and a liquid crystal polymer (LCP). Optionally, the polymer composite material comprises at least one of: graphite, a graphite-derived material such as expanded graphite or graphite nanoplatelets, a graphite-based material, and hexagonal boron nitride. Optionally, the polymer composite material comprises the polymeric material and at least one of graphite, a graphite-derived material such as expanded graphite or graphite nanoplatelets, and hexagonal boron nitride dispersed within the polymeric material. The polymeric material may be a polymeric matrix. The at least one of graphite, a graphite-derived material such as expanded graphite or graphite nanoplatelets, and hexagonal boron nitride may be present in the form of particles, and may be referred to as filler particles. Optionally, the heater comprises the polymeric material in an amount of between 22 and 33 percent by weight of the heater. Optionally, the heater comprises the at least one of graphite, a graphite-derived material, and hexagonal boron nitride in an amount of between 62 and 69 percent by weight of the heater. Optionally, the heater comprises at least one additive dispersed within the polymeric material. Optionally, the at least one additive comprises carbon black. Optionally, the heater comprises the at least one additive in an amount of between 5 and 9 percent by weight of the heater. Thus, the heater may comprise between 22 and 33 weight percent of a polymeric material, such as PEEK or LCP; between 62 and 69 weight percent of one or a combination of graphite, a graphite-derived material, a graphite-based material, and hexagonal boron nitride; and between 5 and 9 weight percent of one or a combination of additives such as carbon black. The at least one power supply may be configured to provide an electric current to such a heater during use to resistively heat the heater. Advantageously, such a heater may be easier to manufacture compared to similar heaters configured for resistive heating that are typically used in existing heaters for aerosol-generating devices. Advantageously, thermoplastic properties of the polymeric material may allow the composite polymer material to be conveniently malleable for precise and controlled shaping. At the same time, by controlling and adjusting the concentration and distribution of the filler particles dispersed within the polymeric matrix, it may advantageously be possible to control the electrical conductivity and, as a consequence, the amount of heat generated resistively by the heater when a voltage is applied to the heater. Other parameters, such as the length and cross-sectional surface area of the heater, may also be adjusted to fine-tune the resistive behaviour of the heater. Advantageously, such a heater may be sufficiently magnetically transparent and highly electrically resistive to minimise the eddy currents induced in the heater as a result of the alternating magnetic field generating by the inductor coil in use.

Optionally, the inductor coil is a helical inductor coil. Optionally, the inductor coils around one or both of the chamber and the heater. Optionally, the inductor coil at least partially surrounds one or both of the chamber and the heater. This may advantageously allow for a concentrated magnetic field in the chamber.

Optionally, the inductor coil at least partially surrounds, for example is wound around, the heater. The inductor coil may or may not be in direct contact with the heater. A spacing component may be present between the inductor coil and the heater. The spacing component may at least partially surround the heater. The inductor coil may at least partially surround, for example be wound around, the spacing component. The spacing component may be electrically insulating. The spacing component may be substantially magnetically transparent. Thus, properties described in relation the optional magnetic transparency of the heater may also be applicable to the spacing component.

As an alternative to a helical inductor coil, the inductor coil may be a flat spiral inductor coil, which may also be referred to as a pancake inductor coil. A flat spiral inductor coil may spiral in a single plane, for example around a central point. Similarly to a helical inductor coil, a flat spiral inductor coil may be configured to generate an alternating magnetic field in the chamber when supplied with an alternating current. The flat spiral inductor coil may form, or be located adjacent to and optionally in contact with, a side wall or the base of the chamber. The flat spiral inductor coil may spiral in a plane which is parallel with the base of the chamber, particularly if the flat spiral inductor coil is located adjacent to and optionally in contact with, the base of the chamber.

The heater may be substantially flat or substantially planar. In this case, the heater may at least partially define the chamber in the sense that the heater defines at least one side wall, or the base, or at least one side wall and the base, of the chamber. It may be particularly advantageous for the heater to be flat if the inductor coil is a flat spiral inductor coil and vice versa. In this case, the flat heater and the flat spiral inductor coil may be located in substantially parallel planes.

The device may comprise a housing. The housing may define at least a portion of the chamber. The housing of the device may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The device may be configured to be held in a single hand during use.

The at least one power supply may be or comprise at least one battery. The or each battery may be rechargeable. The or each battery may be removable from a battery compartment. The or each battery may be a Lithium-based battery, for example a Lithium-Cobalt, a Lithium-Iron-Phosphate, a Lithium Titanate or a Lithium-Polymer battery, or a Nickel-metal hydride or Nickel cadmium battery. The at least one power supply may be or comprise another form of charge storage device such as a capacitor. The at least one power supply may have sufficient capacity to allow for the continuous generation of aerosol for a period of at least six minutes, corresponding to the typical time taken to smoke a conventional cigarette.

According to the present disclosure, there is provided an aerosol-generating system. The aerosol-generating system may comprise an aerosol-generating device as described above, for example the aerosol-generating device according to the first aspect. The aerosol-generating system may comprise an aerosol-generating, for example the aerosol-generating article referred to above with reference to the first aspect.

Thus, according to a second aspect of the present disclosure, there is provided an aerosol-generating system comprising the aerosol-generating device according to the first aspect and the aerosol-generating article referred to in the first aspect.

The system, for example the device, may comprise an air inlet. The system, for example the article or a mouthpiece of the device, may comprise an air outlet. The system, for example the article, may comprise an air flow path. The air flow path may connect the air inlet and the air outlet. In use, air flow through the air flow path may directly contact the aerosol-forming substrate. In use, air flow through the air flow path may flow through or past the aerosol-forming substrate. In use, for example in response to a puff on the article or any mouthpiece of the system, air may flow through the air inlet and then through the article and then through the air outlet. After flowing through the air outlet, the air may flow into a mouth of a user.

As discussed above, the device may comprise a device air inlet, a device air flow path, and a device air outlet. Similarly, the article may comprise an article air inlet, an article air flow path, and an article air outlet. The article air flow path may flow through or past the aerosol-forming substrate. In use, for example in response to a puff on the article or any mouthpiece of the system, air may flow through the device air inlet, then the device air flow path, then the device air outlet, then the article air inlet, then the article air flow path, then the article air outlet, then into a mouth of a user.

The device air inlet may be located at an end of the chamber, for example at the end opposing the base of the chamber. The device air flow path may be at least partially defined between an outer surface of the article and an inner surface of the chamber. The device air flow path may extend from the end opposing the base of the chamber towards, or to, the base of the chamber. The device air outlet may be located at or adjacent to the base of the chamber. The article air inlet may be located at an upstream end of the article. In use, the upstream end of the article may be located at or adjacent to the base of the chamber. The article air flow path may flow through the article from the upstream end to the downstream end. The article air outlet may be located at the downstream end of the article.

The article may comprise, or be, a cartridge. The cartridge may hold the aerosol-forming substrate. The cartridge may hold the susceptor. The cartridge may comprise a cartridge housing. One or both of the aerosol-forming substrate and the susceptor may be located within the cartridge housing.

The cartridge may have a length, a width, and a thickness. The thickness may be less than 0.5 or 0.2 times the length, the width, or both. In this case, the cartridge may be termed a flat or planar cartridge. The cartridge may be any suitable shape and size, for example substantially right cylindrical or cuboid. The cartridge may be any of the cartridges described in WO2015177043, the contents of which is incorporated herein.

The susceptor may have a susceptor length, a susceptor width, and a susceptor thickness. The susceptor thickness may be less than 0.5 or 0.2 times the susceptor length, the susceptor width, or both. In this case, the susceptor may be termed a flat or planar susceptor. The aerosol-forming substrate may have a substrate length, a substrate width, and a substrate thickness. The substrate thickness may be less than 0.5 or 0.2 times the substrate length, the substrate width, or both. In this case, the aerosol-forming substrate may be termed a flat or planar aerosol-forming substrate.

The susceptor may form, be attached to, or be located adjacent to, an inner face of the cartridge housing. The susceptor may be in contact with the aerosol-forming substrate. The susceptor may be located between the aerosol-forming substrate and the inner face. A largest or second largest surface of the susceptor may be in contact with, or located adjacent to, a largest or second largest surface of the aerosol-forming substrate. This may be particularly advantageous where one or both of the susceptor and the aerosol-forming substrate are flat or planar. Advantageously, this may maximise heat transfer from the susceptor to the aerosol-forming substrate in use.

The article may appear substantially similar to a conventional cigarette. The article may be substantially cylindrical, for example right cylindrical, in shape. The article may have a length of between 30 mm and 120 mm, for example between 40 mm and 80 mm, for example about 45 mm. The article may have a diameter of between 3.5 mm and 10 mm, for example between 4 mm and 8.5 mm, for example between 4.5 mm and 7.5 mm.

The substrate may be substantially cylindrical, for example right cylindrical, in shape. References herein have been made to an inner portion and an outer portion of the aerosol-forming substrate. The inner portion may be or comprise aerosol-forming material in an axially central portion, for example axially central cylindrical portion or axially central right cylindrical portion, of the aerosol-forming substrate. The outer portion may be or comprise aerosol-forming material in an axially outer portion of the aerosol-forming substrate. The outer portion may be cylindrical, for example right cylindrical in shape. The outer portion may have an annular, for example circular annular, cross-section. There may be no aerosol-forming substrate between the inner and outer portions. The inner portion and outer portion may be in contact. An entirety of the aerosol-forming material of the aerosol-forming substrate may be found in the inner and outer portions.

Optionally, the article comprises a front plug. Optionally, the article comprises an aerosol-forming substrate. Optionally, the article comprises a first hollow tube, for example a first hollow acetate tube. Optionally, the article comprises a second hollow tube, for example a second hollow acetate tube. Optionally, the second hollow tube comprises one or more ventilation holes. Optionally, the article comprises a mouth plug filter. Optionally, the article comprises wrapper, for example a paper wrapper. Optionally, one or more or all of the front plug, the aerosol-forming substrate, the first hollow tube, the second hollow tube where present, and the mouth plug filter are circumscribed by the wrapper.

Optionally, the front plug is arranged at a most upstream end of the article. Optionally, the aerosol-forming substrate is arranged downstream of the front plug. Optionally, the first hollow tube is arranged downstream of the aerosol-forming substrate. Optionally, the second hollow tube is arranged downstream of the first hollow tube. Optionally, the mouth plug filter is arranged downstream of one or both of the first hollow tube and the second hollow tube. Optionally, the mouth plug filter is arranged at a most downstream end of the article. Optionally, the most downstream end of the article, which may be referred to as a mouth end of the article, may be configured for insertion into a mouth of a user. A user may be able to inhale on, for example directly on, the mouth end of the article.

One or more of the front plug, the aerosol-forming substrate, the first hollow tube, the second hollow tube, and the mouth plug filter may be substantially cylindrical, for example right cylindrical, in shape. One or more of the front plug, the aerosol-forming substrate, the first hollow tube, the second hollow tube, and the mouth plug filter may have a diameter of between 3.5 mm and 10 millimetres. Optionally, the front plug has a length of between 2 and 10 millimetres. Optionally, the aerosol-forming substrate within the article has a length of between 5 and 20 millimetres. Optionally, the first hollow tube has a length of between 2 and 20 millimetres. Optionally, the second hollow tube has a length of between 2 and 20 millimetres. Optionally, the mouth plug filter has a length of between 5 and 20 millimetres.

According to the present disclosure, there is provided a method of controlling an aerosol-generating device or an aerosol-generating system. The aerosol-generating device may be an aerosol-generating device as described above, for example the aerosol-generating device according to the first aspect. The aerosol-generating system may be an aerosol-generating system as described above, for example the aerosol-generating system according to the second aspect.

Thus, according to a third aspect of the present disclosure, there is provided a method of controlling an aerosol-generating device according to the first aspect or an aerosol-generating system according to the second aspect.

Features described in relation to one aspect may be applicable to another aspect. For example, features described in relation to the device of the first aspect may be applicable to one or both of the system of the second aspect and the method of the third aspect, features described in relation to the system of the second aspect may be applicable to one or both of the device of the first aspect and the method of the third aspect, and features described in relation to the method of the third aspect may be applicable to one or both of the device of the first aspect and the system of the second aspect.

In particular, as the skilled person would understand after reading this disclosure, features described in relation to what the controller may be configured to do in relation to the first aspect may be applicable to the method of the third aspect. The method may comprise any of the steps that the controller of the device of the first aspect is configured to do.

Optionally, the device comprises at least one power supply, and the method comprises independently controlling a supply of power from the at least one power supply to the heater and a supply of power from the at least one power supply to the inductor coil. Optionally, the device comprises a first power supply and a second power supply distinct from the first power supply, and the method comprises independently controlling a supply of power from the first power supply to the heater and a supply of power from the second power supply to the inductor coil. Advantageously, independent controlling supplies of power to the inductor coil and the heater may allow independent control of their temperatures.

Optionally, the method comprises, during the maintenance phase, controlling a supply of power from the at least one power supply to one or both of the inductor coil and the heater to maintain a temperature of a heating zone within the heating zone maintenance temperature range. All optional features discussed above relating to the heating zone maintenance temperature range apply. Optionally, the method comprises, during the maintenance phase, supplying no power from the at least one power supply to the inductor coil.

Optionally, the method comprises one or both of ending the maintenance phase and initiating the puffing phase when the device, for example the puff detection mechanism of the device, detects a puff or a start of a puff. Optionally, the method comprises adjusting, for example increasing, one or both of a supply of power to the heater and a supply of power to the inductor coil when the device, for example the puff detection mechanism of the device, detects a puff or a start of a puff. Advantageously, this may allow the device to quickly respond to a user puff and generate an aerosol accordingly.

Optionally, the method comprises, during the puffing phase, controlling a supply of power from the at least one power supply to one or both of the inductor coil and the heater to maintain a temperature of a heating zone within the heating zone puffing temperature range. All optional features discussed above relating to the heating zone puffing temperature range apply.

Optionally, the method comprises adjusting, for example decreasing, one or both of a supply of power to the heater and a supply of power to the inductor coil when the device, for example the puff detection mechanism of the device, detects an end of a puff. Optionally, the method comprises one or both of ending the puffing phase and initiating the maintenance phase when the device, for example the puff detection mechanism of the device, detects an end of a puff. Advantageously, this may allow the device to quickly respond to a user puff ending and stop generating an aerosol accordingly. Reverting to the maintenance phase may advantageously allow the device to keep the aerosol-forming substrate warm so as to reduce a time required to generate an aerosol in response to detecting a start of the next puff.

Optionally, the method comprises, in response to the device, for example the puff detection mechanism of the device, detecting a puff, adjusting a supply of power from the at least one power supply to the inductor coil, for example to increase a temperature of the susceptor.

Optionally, the method comprises not adjusting a supply of power from the at least one power supply to the heater in response to the device, for example the puff detection mechanism of the device, detecting a puff. Optionally, the method comprises, in response to the device, for example the puff detection mechanism of the device, detecting a puff, controlling a supply of power from the at least one power supply to the heater in an identical manner to during the maintenance phase.

References herein to a supply of power may refer to a supply of electrical power, for example a supply of electrical current under a potential difference or voltage. References herein to controlling a supply of power may refer to controlling one or both of a current and a voltage of that power. For example, controlling a supply of power may comprise controlling one or more of an amplitude of the current, a frequency of the current, and an amplitude of the voltage, of that power.

As used herein, the term “aerosol-generating article”, or simply “article” for short, may refer to an article able to generate, or release, an aerosol, for example when heated.

As used herein, the term “aerosol-forming substrate” may refer to a substrate capable of releasing an aerosol or volatile compounds that can form an aerosol. Such volatile compounds may be released by heating the aerosol-forming substrate. The aerosol-forming substrate may comprise one or more aerosol formers or aerosol-forming materials. An aerosol-forming substrate may be adsorbed, coated, impregnated or otherwise loaded onto a carrier or support. An aerosol-forming substrate may conveniently be part of an aerosol-generating article or smoking article.

Optionally, the aerosol-forming substrate is a solid aerosol-forming substrate. However, the aerosol-forming substrate may comprise both solid and liquid components. Alternatively, the aerosol-forming substrate may be a liquid aerosol-forming substrate.

Optionally, the aerosol-forming substrate comprises nicotine. Optionally, the aerosol-forming substrate comprises tobacco. Alternatively, or in addition, the aerosol-forming substrate may comprise a non-tobacco containing aerosol-forming material.

As used herein, the term “aerosol former” may refer to any suitable known compound or mixture of compounds that, in use, facilitates formation of an aerosol and that is substantially resistant to thermal degradation at the operating temperature of the aerosol-generating article. Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di-or triacetate; and aliphatic esters of mono-, di-or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine. The aerosol-forming substrate may comprise one or more aerosol formers.

As used herein, the “aerosolisation temperature” of an aerosol-forming substrate may refer to a minimum temperature at which the aerosol-forming substrate releases an aerosol or volatile compounds that can form an aerosol, or at which the aerosol-forming substrate releases a substantial quantity of an aerosol or volatile compounds that can form an aerosol.

As used herein, the term “usage session” may refer to a period in which a series of puffs are applied by a user to extract aerosol from an aerosol-forming substrate.

As used herein, the term “aerosol-generating device” may refer to a device for use with an aerosol-generating article to enable the generation, or release, of an aerosol.

As used herein, the term “susceptor” may refer to an element comprising a material that is capable of converting the energy of a magnetic field into heat. When a susceptor is located in an alternating magnetic field, the susceptor may be heated. Heating of the susceptor may be the result of at least one of hysteresis losses and eddy currents induced in the susceptor, depending on the electrical and magnetic properties of the susceptor material.

As used herein when referring to an aerosol-generating article, the terms “upstream” and “downstream” may be used to describe the relative positions of components, or portions of components, of the aerosol-generating article in relation to the direction in which air flows through the aerosol-generating article during use thereof. Aerosol-generating articles may comprise an upstream end through which, in use, air enters the article. Aerosol-generating articles may comprise a downstream end through which, in use, air or aerosol exits the article.

Various references have been made to ranges herein, such as temperature ranges. For the avoidance of doubt, unless otherwise specified, any ranges referred to herein may have only an upper limit, only a lower limit, or both an upper limit and a lower limit. A limit for a temperature range, for example any upper or lower limit of any one or more of the temperature ranges for the heating zone, heater, or susceptor as discussed above, may be predetermined. The limit may be stored in the controller or in a memory, for example in a memory of the controller. The limit may be stored as a temperature value or in another form indicative of a temperature value, for example as a value of an electrical resistance of the component to which the temperature range applies. In this case, the electrical resistance of the component may be monitored, rather than the temperature of the component, and compared with a temperature versus electrical resistance dataset to estimate the temperature of the component.

As used herein, the term “electrically insulating” may refer to a material having an electrical conductivity of less than 0.8×10⁴ Siemens per metre in at least one direction, for example in all directions, at room temperature (20 degrees Celsius) and a relative humidity of 50%.

As used herein, the term “electrically resistive” may refer to a material having an electrical conductivity of at least 0.8×10⁶ Siemens per metre in at least one direction, for example in all directions, at room temperature (20 degrees Celsius) and a relative humidity of 50%.

As used herein, the term “thermally conductive” may refer to a material having a thermal conductivity of at least 5, 10, 20, 50, or 100 Watts per metre-Kelvin in at least one direction, for example in all directions, at room temperature (20 degrees Celsius) and a relative humidity of 50%.

The invention is defined in the claims. However, below there is provided a non-exhaustive list of non-limiting examples. Any one or more of the features of these examples may be combined with any one or more features of another example, embodiment, or aspect described herein.
Ex1. An aerosol-generating device comprising:
   a chamber for receiving at least a portion of an aerosol-generating article comprising an aerosol-forming substrate;
   a heater at least partially surrounding or defining the chamber and configured to provide a heating zone in the chamber; and
   an inductor coil configured to generate an alternating magnetic field in the chamber when the inductor coil is supplied with an alternating current.
Ex2. An aerosol-generating device according to example Ex1, wherein the device comprises at least one power supply and a controller.
Ex3. An aerosol-generating device according to example Ex2, wherein the controller is configured to independently control a supply of power from the at least one power supply to the heater and a supply of power from the at least one power supply to the inductor coil.
Ex4. An aerosol-generating device according to any preceding example, wherein the device comprises a first power supply and a second power supply different to the first power supply.
Ex5. An aerosol-generating device according to example Ex2 when dependent on example Ex3, wherein the controller is configured to independently control a supply of power from the first power supply to the heater and a supply of power from the second power supply to the inductor coil.
Ex6. An aerosol-generating device according to example Ex2 or any preceding example when dependent on Example Ex2, wherein during a maintenance phase, the controller is configured to control a supply of power from the at least one power supply to one or both of the inductor coil and the heater to maintain a temperature of the heating zone within a heating zone maintenance temperature range.
Ex7. An aerosol-generating device according to example Ex6, wherein the heating zone maintenance temperature range has an upper limit which is less than an aerosolisation temperature required for the aerosol-forming substrate to form an aerosol.
Ex8. An aerosol-generating device according to example Ex6 or Ex7, wherein the heating zone maintenance temperature range has an upper limit of no more than 250, 200, or 170 degrees Celsius.
Ex9. An aerosol-generating device according to any of examples Ex6 to Ex8, wherein the heating zone maintenance temperature range has a lower limit of at least 50, 100, or 140 degrees Celsius.
Ex10. An aerosol-generating device according to any of examples Ex6 to Ex9, wherein the heating zone maintenance temperature range is between 50 and 250, 50 and 200, 50 and 170, 100 and 250, 100 and 200, 100 and 170, 140 and 250, 140 and 200, 140 and 170 degrees Celsius.
Ex11. An aerosol-generating device according to example Ex2 or any preceding example when dependent on Example Ex2, wherein during a maintenance phase, the controller is configured to control a supply of power from the at least one power supply to the heater to maintain a temperature of the heater within a heater maintenance temperature range.
Ex12. An aerosol-generating device according to example Ex11, wherein the heater maintenance temperature range has an upper limit which is less than a temperature required for the heater to heat the aerosol-forming substrate sufficiently to form an aerosol.
Ex13. An aerosol-generating device according to example Ex11 or Ex12, wherein the heater maintenance temperature range has an upper limit of no more than 250, 200, or 170 degrees Celsius.
Ex14. An aerosol-generating device according to example Ex11, Ex12, or Ex13, wherein the heater maintenance temperature range has a lower limit of at least 50, 100, or 140 degrees Celsius.
Ex15. An aerosol-generating device according to any preceding example, wherein the aerosol-generating article comprises a susceptor.
Ex16. An aerosol-generating device according to any of examples Ex1 to Ex15, wherein the device comprises a susceptor.
Ex17. An aerosol-generating device according to example Ex15 or Ex16, wherein the susceptor is a pin, blade or rod projecting into the chamber.
Ex18. An aerosol-generating device according to example Ex15 or Ex16 or Ex17, when dependent on Example Ex2, wherein during a maintenance phase, the controller is configured to supply no power from the at least one power supply to the inductor coil.
Ex19. An aerosol-generating device according to example Ex15 or Ex16 or Ex17, when dependent on Example Ex2, wherein during a maintenance phase, the controller is configured to control a supply of power from the at least one power supply to the inductor coil to maintain a temperature of the susceptor in the chamber within a susceptor maintenance temperature range.
Ex20. An aerosol-generating device according to example Ex19, wherein the susceptor maintenance temperature range has an upper limit which is less than a temperature required for the susceptor to heat the aerosol-forming substrate sufficiently to form an aerosol.
Ex21. An aerosol-generating device according to example Ex19 or Ex20, wherein the susceptor maintenance temperature range has an upper limit of no more than 250, 200, or 170 degrees Celsius.
Ex22. An aerosol-generating device according to example Ex19, Ex20, or Ex21, wherein the susceptor maintenance temperature range has a lower limit of at least 50, 100, or 140 degrees Celsius.
Ex23. An aerosol-generating device according to any preceding example, wherein the device comprises a flow restrictor such as a venturi tube.
Ex24. An aerosol-generating device according to any preceding example, wherein the device comprises a puff detection mechanism.
Ex25. An aerosol-generating device according to example Ex24, wherein the puff detection mechanism comprises a pressure sensor.
Ex26. An aerosol-generating device according to example Ex25 when dependent on example Ex23, wherein the pressure sensor is configured to sense a pressure of an air flow through the flow restrictor.
Ex27. An aerosol-generating device according to example Ex24 or Ex25 or Ex26, when dependent on example Ex2, wherein the controller is configured to one or both of end a maintenance phase and initiate a puffing phase when the puff detection mechanism detects a puff or a start of a puff.
Ex28. An aerosol-generating device according to example Ex24 or Ex25 or Ex26 or Ex27, when dependent on example Ex2, wherein the controller is configured to one or both of initiate a maintenance phase and end a puffing phase when the puff detection mechanism detects an end of a puff.
Ex29. An aerosol-generating device according to example Ex2 or any preceding example when dependent on example Ex2, wherein the controller is configured to adjust, for example increase, one or both of a supply of power to the heater and a supply of power to the inductor coil based on the device detecting, determining or estimating any one or more of the following:
   a start of a puff;
   a time duration of a puff so far reaching, for example increasing to above, a first threshold;
   a volume of a puff so far reaching, for example increasing to above, a first threshold;
   an instantaneous flow rate of an air flow resulting from the puff reaching, for example increasing to above, a first threshold;
   an instantaneous flow rate of an air flow resulting from the puff staying above a first threshold for at least a first time period;
   an instantaneous rate of change of flow rate of an air flow resulting from the puff reaching, for example increasing to above, a first threshold;
   an instantaneous rate of change of flow rate of an air flow resulting from the puff staying above a first threshold for at least a first time period;
   a temperature of the heating zone or the heater decreasing to below a lower threshold; and
   a temperature of the heating zone or the heater staying below a lower threshold for at least a first time period.
Ex30. An aerosol-generating device according to example Ex2 or any preceding example when dependent on example Ex2, wherein controller may be configured to adjust, for example decrease, one or both of a supply of power to the heater and a supply of power to the inductor coil based on the device detecting, determining or estimating any one or more of the following:
   an end of a puff;
   a time duration of a puff so far reaching, for example increasing to above, a second threshold;
   a volume of a puff so far reaching, for example increasing to above, a second threshold;
   an instantaneous flow rate of an air flow resulting from the puff reaching, for example decreasing to below, a second threshold;
   an instantaneous flow rate of an air flow resulting from the puff staying below a second threshold for at least a second time period;
   an instantaneous rate of change of flow rate of an air flow resulting from the puff reaching, for example decreasing to below, a second, optionally negative, threshold;
   an instantaneous rate of change of flow rate of an air flow resulting from the puff staying below a second, optionally negative, threshold for at least a second time period;
   a temperature of the heating zone or the heater increasing above an upper threshold; and
   a temperature of the heating zone or the heater staying above an upper threshold for a time period.
Ex31. An aerosol-generating device according to example Ex2 or any preceding example when dependent on example Ex2, wherein in response to the device detecting a puff, the controller is configured to increase a supply of power from the at least one power supply to one or both of the inductor coil and the heater.
Ex32. An aerosol-generating device according to example Ex2 or any preceding example when dependent on example Ex2, wherein in response to the device detecting a puff, the controller is configured to adjust, for example increase, a supply of power from the at least one power supply to one or both of the inductor coil and the heater to increase a temperature of the heating zone, for example to within a heating zone puffing temperature range.
Ex33. An aerosol-generating device according to example Ex32, wherein a lower limit of the heating zone puffing temperature range is sufficiently high temperature for the aerosol-forming substrate to form an aerosol.
Ex34. An aerosol-generating device according to example Ex32 or Ex33, wherein a lower limit of the heating zone puffing temperature range is at least 200, 250, or 300 degrees Celsius.
Ex35. An aerosol-generating device according to example Ex32 or Ex33 or Ex34, wherein a lower limit of the heating zone puffing temperature range is no more than 800, 650, or 500 degrees Celsius.
Ex36. An aerosol-generating device according to any preceding example, wherein the heater is configured to contact the aerosol-generating article when the aerosol-generating article is at least partially received in the chamber.
Ex37. An aerosol-generating device according to any preceding example, wherein the heater is substantially tubular.
Ex38. An aerosol-generating device according to any preceding example, wherein the heater is an electrically resistive heater.
Ex39. An aerosol-generating device according to any preceding example, wherein the heater is substantially transparent to the alternating magnetic field generated by the inductor coil when the inductor coil is supplied with an alternating current.
Ex40. An aerosol-generating device according to any preceding example, wherein the heater comprises, for example at least 90% by weight, or consists of materials which are one or more of: substantially non-ferromagnetic; substantially paramagnetic; and substantially diamagnetic.
Ex41. An aerosol-generating device according to any preceding example, wherein the heater comprises, for example at least 90% by weight, or consists of materials having one or both of: a maximum, relative magnetic permeability of no more than 2, 1.5, or 1.1; and a maximum, relative magnetic permeability of at least 0.99, 0.999, or 1.
Ex42. An aerosol-generating device according to any preceding example, such as example Ex40 or Ex 41, wherein the heater comprises, for example at least 90 percent by weight, or consists of materials having an electrical conductivity of less than 0.8×10⁴ or 0.8×10³ or 0.8×10² Siemens per metre in at least one direction, for example in all directions, at 20 degrees Celsius and a relative humidity of 50%.
Ex43. An aerosol-generating device according to any preceding example, wherein the heater comprises a ceramic material.
Ex44. An aerosol-generating device according to any preceding example, wherein the heater comprises a polymer composite material.
Ex45. An aerosol-generating device according to example Ex44, wherein the polymer composite material comprises a polymeric material, for example at least one polymeric material selected from the list: Polyether ether ketone (PEEK) and a liquid crystal polymer (LCP).
Ex46. An aerosol-generating device according to any of examples Ex44 to Ex45, wherein the polymer composite material comprises at least one of: graphite, a graphite-derived material, a graphite-based material, and hexagonal boron nitride.
Ex47. An aerosol-generating device according to example Ex44, wherein the polymer composite material comprises a polymeric material, such as at least one polymeric material selected from the list: Polyether ether ketone (PEEK) and a liquid crystal polymer (LCP), and at least one of: graphite, a graphite-derived material such as expanded graphite or graphite nanoplatelets, and hexagonal boron nitride dispersed within the polymeric material.
Ex48. An aerosol-generating device according to example Ex45 or Ex47, wherein the heater comprises the polymeric material in an amount of between 22 and 33 percent by weight of the heater.
Ex49. An aerosol-generating device according to example Ex46 or Ex47, wherein the heater comprises the at least one of graphite, a graphite-derived material, and hexagonal boron nitride in an amount of between 62 and 69 percent by weight of the heater.
Ex50. An aerosol-generating device according to any of examples Ex45 or Ex47 or Ex48, or example Ex49 when dependent on example Ex47, wherein the heater comprises at least one additive dispersed within the polymeric material.
Ex51. An aerosol-generating device according to example Ex50, wherein the at least one additive comprises carbon black.
Ex52. An aerosol-generating device according to example Ex50 or Ex51, wherein the heater comprises the at least one additive in an amount of between 5 and 9 percent by weight of the heater.
Ex53. An aerosol-generating device according to any preceding example, wherein the inductor coil at least partially surrounds the chamber.
Ex54. An aerosol-generating device according to any preceding example, wherein the inductor coil at least partially surrounds the heater.
Ex55. An aerosol-generating device according to any preceding example, wherein the inductor coil is a helical inductor coil.
Ex56. An aerosol-generating device according to any preceding example, wherein the chamber comprises an open first end, optionally through which at least a portion of an aerosol-generating article may be inserted into the chamber.
Ex57. An aerosol-generating device according to any preceding example, wherein the chamber comprises an at least partially closed second end.
Ex58. An aerosol-generating device according to example Ex56, wherein the chamber comprises an at least partially closed second end opposite the open first end.
Ex59. An aerosol-generating system comprising an aerosol-generating device according to any preceding example and the aerosol-generating article.
Ex60. A method of controlling an aerosol-generating device according to any preceding device example, wherein the device comprises at least one power supply, and the method comprises independently controlling a supply of power from the at least one power supply to the heater and a supply of power from the at least one power supply to the inductor coil.
Ex61. A method according to any preceding method example, wherein the device comprises a first power supply and a second power supply distinct from the first power supply, and the method comprises independently controlling a supply of power from the first power supply to the heater and a supply of power from the second power supply to the inductor coil.
Ex62. A method according to any preceding method example, wherein the method comprises, during a maintenance phase, controlling a supply of power from the at least one power supply to one or both of the inductor coil and the heater to maintain a temperature of the heating zone within a heating zone maintenance temperature range.
Ex63. A method according to any preceding method example, wherein the method comprises, in response to detecting a puff, controlling a supply of power from the at least one power supply to one or both of the inductor coil and the heater to increase a temperature of the heating zone, optionally to within a heating zone puffing temperature range.
Ex64. A method according to any preceding method example, wherein the method comprises, in response to detecting a puff, adjusting a supply of power from the at least one power supply to the inductor coil, for example to increase a temperature of the susceptor.
Ex65. A method according to any preceding method example, wherein the method comprises not adjusting a supply of power from the at least one power supply to the heater in response to detecting a puff.
Ex66. A method according to any preceding method example, wherein the method comprises, in response to the detecting a puff, controlling a supply of power from the at least one power supply to the heater in an identical manner to during a maintenance phase.

Examples will now be further described with reference to the figures in which:

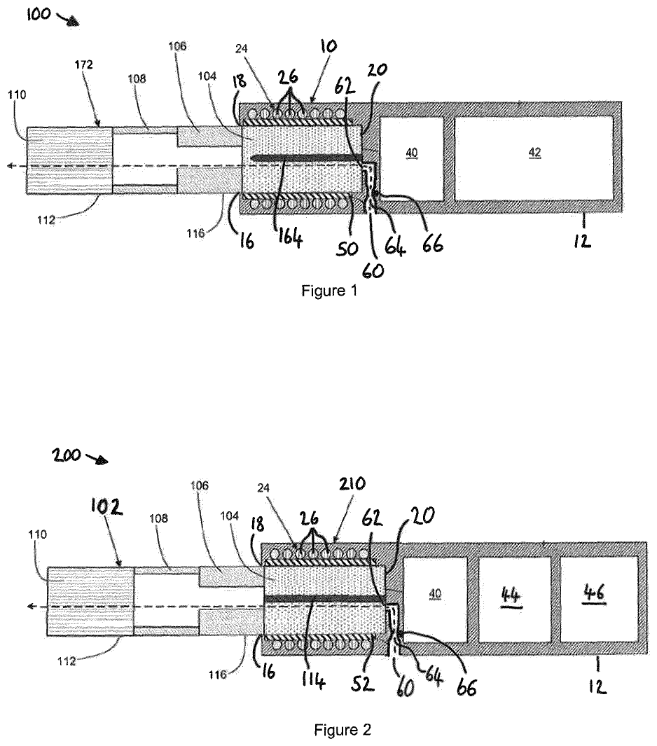

FIG. 1 shows a first aerosol-generating system; and

FIG. 2 shows a second aerosol-generating system.

FIG. 1 shows a first aerosol-generating system 100. The system 100 comprises a first aerosol-generating device 10 and a first aerosol-generating article 172.

The device 10 comprises a housing 12 and a right cylindrical chamber 16 for receiving a portion of the right cylindrical article 172. The chamber 16 comprises an open end 18 through which the article 172 may be inserted into the chamber 16, and a mostly closed end 20, also referred to as a base 20, opposite the open end 18. The diameter of the chamber 16 is slightly larger than the diameter of the article 172 to allow insertion of the article 172 into the chamber 16.

The device 10 comprises a heater 50. The heater 50 is substantially tubular in shape and extends from the base 20 of the chamber 16 to the open end 18 of the chamber 16 to define the chamber 16. The heater 50 is an electrically resistive heater formed of a polymer composite material. Specifically, the heater 50 comprises a polymeric material and at least one of graphite, a graphite-derived material, and hexagonal boron nitride dispersed within the polymeric material. The polymeric material is polyether ether ketone (PEEK) but could be a liquid crystal polymer (LCP) instead. The heater 50 comprises the polymeric material in an amount of 27 percent by weight of the heater 50, though this amount could be anywhere between 22 percent and 33 percent. The graphite-derived material comprises at least one of expanded graphite and graphite nanoplatelets. The heater 50 comprises the at least one of graphite, a graphite-derived material, and hexagonal boron nitride in an amount of 65 percent by weight of the heater 50, though this could be between anywhere 62 percent and 69 percent. The heater 50 further comprises an additive, carbon black, dispersed within the polymeric material. The heater 50 comprises the additive in an amount of 7 percent by weight of the heater 50, though this could be anywhere between 5 percent and 9 percent. The heater 50 is not inductively heatable. The heater 50 is substantially transparent to the alternating magnetic field generated by the inductor coil 24 in use. Thus, the heater 50 has no interaction, or a negligible interaction, with the alternating magnetic field generated by the inductor coil 24, and therefore the heating of the susceptor element 164 described later, in use.

The device 10 comprises a helical inductor coil 24 comprising a plurality of windings 26 surrounding the heater 50.

The device 10 comprises a susceptor element 164 in a radially central position in the chamber 16, projecting from the base 20 of the chamber 16 towards the open end 18 of the chamber 16. The susceptor element 164 is shaped like a blade to facilitate penetrating the article 172 when the article 172 is received in the chamber 16, as shown in FIG. 1. The susceptor element 164 is configured to be inductively heated by the inductor coil 24.

The device 10 comprises a device air inlet 60 in a side of the housing 12, a device air outlet 62 in the base 20 of the chamber 16, and a device air flow path connecting the device air inlet 60 and the device air outlet 62. A flow restrictor 64 in the form of a venturi tube is located in the device air flow path. The device 10 comprises a puff detection mechanism comprising a pressure sensor 66. The pressure sensor 66 is arranged to sense a pressure of an air flow in the flow restrictor 64.

The device 10 comprises a controller 40 and a power supply 42 connected to the controller 40. The controller 40 is connected to the puff detection mechanism. Both the controller 40 and the power supply 42 are connected to the inductor coil 24 and the heater 50. The controller 40 is configured to control a supply of power from the power supply 42 to the inductor coil 24. Specifically, the controller 40 is configured to provide a high frequency alternating electric current from the power supply 42 to the inductor coil 24 to generate an alternating magnetic field within the chamber 16. The controller 40 is also configured to control a supply of power from the power supply 42 to the heater 50. Specifically, the controller 40 is configured to provide a direct electric current from the power supply 42 to the heater 50 to resistively heat the heater 50.

The article 172 comprises an aerosol-forming substrate 104 in the form of a tobacco plug, a first hollow acetate tube 106, a second hollow acetate tube 108, a mouthpiece 110, and an outer wrapper 112. The article 172 is substantially right cylindrical in shape and has a similar length and diameter to a traditional cigarette.

Use of the system 100 will now be described. During use, a portion of the article 172 is inserted into the chamber 16 so that the susceptor element 164 penetrates the aerosol-forming substrate 104. This position is shown in FIG. 1. The user then presses a button (not shown) to activate the device 10. In response, the controller 40 supplies power from the power supply 42 to the heater 50 in the form of a direct current until the heater 50 reaches a temperature of around 150 degrees Celsius. In this embodiment, the temperature of the heater 50 is determined by the controller 40 by using the current and voltage being supplied to the heater 50 to determine the resistance of the heater 50, and then comparing that resistance with a look-up table stored in a memory of the device 100 showing how the resistance of the heater 50 varies with its temperature. However, in other embodiments, a temperature sensor for sensing the temperature of the heater 50 could be used. Once the temperature of the heater 50 reaches around 150 degrees Celsius, the power supplied to the heater 50 is continuously adjusted to maintain the temperature of the heater 50 at around 150 degrees Celsius, until a puff is detected, as explained later.

The phase during which the heater 50 is maintained at around 150 degrees Celsius, which is slightly below an aerosolisation temperature, of around 170 degrees Celsius in this embodiment, required for the aerosol-forming substrate 104 to form an aerosol, is referred to as a maintenance phase. During the maintenance phase, no power is supplied to the inductor coil 24. Once the heater 50 reaches 150 degrees Celsius, an indicator (not shown) such as a light, speaker, or haptic feedback device, indicates to the user that the device 10 is ready for puffing.

The user then puffs, or inhales, on the mouthpiece 110 of the article 172. This results in an air flow being drawn through the device air inlet 60, through the flow restrictor 64, through the device air outlet 66, then through the article 172, then into the mouth of the user. This air flow path is illustrated by a dashed line in FIG. 1.

The flow restrictor 64 reduces a cross-sectional area of the device air flow path. Thus, as air flows through the flow restrictor 64, the air flow accelerates and reduces in pressure. The pressure in the flow restrictor 64 is sensed by the pressure sensor 66 of the puff detection mechanism and relayed continuously, or at frequent intervals such as every 50 milliseconds, to the controller 40. When the pressure in the flow restrictor reduces by a significant amount, thus indicating a user is puffing on the mouthpiece 110, the maintenance phase ends and the puffing phase begins.

In response to detecting the puff, at the start of the puffing phase, the controller 40 does not alter the power supplied to the heater 50 but starts providing an alternating electric current from the power supply 42 to the inductor coil 24. This results in the generation of an alternating magnetic field in the chamber 16 that inductively heats the susceptor element 164 by causing eddy currents and hysteresis losses in the susceptor element 164. The susceptor element 164 then heats the aerosol-forming substrate 104 to above the aerosolisation temperature of the aerosol-forming substrate 104 form an aerosol.

In this embodiment, during the puffing phase, the controller 40 maintains the temperature of the heater 50 at around 150 degrees Celsius, in the same way as explained with reference to the maintenance phase. During the puffing phase, the controller 40 controls a supply of power from the power supply 42 to the inductor coil 24 to heat the susceptor element 164 such that the susceptor reaches around 400 degrees Celsius and an average temperature in the heating zone reaches around 300 degrees Celsius. One or more temperature sensors supply feedback relating to the temperature of one or both of the heating zone and the susceptor element 164 to the controller 40 to allow the controller 40 to control the supply of power to the susceptor element 164 to one or both of maintain the temperature of the susceptor at around 400 degrees Celsius and maintain the average temperature in the heating zone at around 300 degrees Celsius.

As the airflow passes through the aerosol-forming substrate 104 during the puffing phase, as illustrated by the dashed line in FIG. 1, aerosol generated by heating of the aerosol-forming substrate 104 is entrained in the airflow. The aerosol then flows along the length of the article 172 and through the mouthpiece 110 to the user.

When the pressure sensor 66 senses the pressure in the flow restrictor 64 has returned to atmospheric or near atmospheric pressure, this may indicate that the puff has ended. When the controller 40 determines that the puff has ended, the controller 40 ends the puffing phase and returns to the maintenance phase. Thus, the controller 40 stops supplying power to the inductor coil 24 and maintains the supply of power to the heater 50 to maintain a temperature of the heater at around 150 degrees Celsius.

Similar puffing phases are repeated for each of a plurality of puffs during the usage session. After each puffing phase, there is a maintenance phase. After a number of puffing phases during the usage session, or after a time has lapsed after the first puffing phase of the usage session, the indicator indicates to the user that the usage session is ending. This may coincide with when it's expected that most of the aerosol-forming substrate 104 has been heated sufficiently to form an aerosol, so the aerosol-forming substrate 104 is substantially depleted. The controller 40 then stops supplying power to the heater 50 and the inductor coil 24. The device 10 may then turn off and wait to be re-activated by the button for another usage session.

FIG. 2 shows a second aerosol-generating system 200. The system 200 comprises a second aerosol-generating device 210 and a second aerosol-generating article 102. The second aerosol-generating system 200 is similar to the first aerosol-generating system 100 so only the differences are described here. Like reference numerals are used to designate like features.

The device 210 of FIG. 2 does not comprise a susceptor element. In the system 200 of FIG. 2, the article 102 comprises a susceptor element 114. The susceptor element 114 is located in a radially central position in the aerosol-forming substrate 104 and extends along the entire length of the aerosol-forming substrate 104.

The device 210 of FIG. 2 does not comprise the heater 50, but a different heater 52 instead. The heater 52 is substantially tubular in shape and extends from the base 20 of the chamber 16 to the open end 18 of the chamber 16 to define the chamber 16. The heater 52 comprises a substantially tubular, electrically insulating substrate made of a ceramic. The heater 52 comprises an electrically resistive track on an inner surface of the electrically insulating substrate. The heater 52 comprises a thin protective coating, such as a glass or ceramic coating, over the electrically resistive track and optionally also over the inner surface of the electrically insulating substrate. The protective coating prevents direct contact between an article inserted into the chamber 16 and the electrically resistive track. The heater 52 is not inductively heatable. The heater 52 is substantially transparent to the alternating magnetic field generated by the inductor coil 24 in use. The heater 52 consists of substantially non-ferromagnetic materials. The heater 52 has no interaction, or a negligible interaction, with the alternating magnetic field generated by the inductor coil 24, and therefore the heating of the susceptor element 114 described later, in use.

The device 210 of FIG. 2 comprises a first power supply 44 and a second power supply 46, rather than the single power supply 42 of the device 100 of FIG. 1. The first power supply 44 is connected to the controller 40 and the heater 52. The second power supply 46 is connected to the controller 40 and the inductor coil 24. Similarly to the device 10 of FIG. 1, in the device 210 of FIG. 2, the controller 40 is connected to the puff detection mechanism. The controller 40 is configured to control a supply of power from the first power supply 44 to the heater 52. Specifically, the controller 40 is configured to provide a direct electric current from the first power supply 44 to the electrically resistive track of the heater 52 to resistively heat the track. The controller 40 is configured to control a supply of power from the second power supply 46 to the inductor coil 24. Specifically, the controller 40 is configured to provide a high frequency alternating electric current from the second power supply 46 to the inductor coil 24 to generate an alternating magnetic field within the chamber 16.

Use of the system 200 will now be described. During use, a portion of the article 102 is inserted into the chamber 16. This position is shown in FIG. 2. The user then presses a button (not shown) to activate the device 210. In response, the controller 40 supplies power from the first power supply 44 to the heater 52, specifically the electrically resistive track, in the form of a direct current until the heater 52 reaches a temperature of around 100 degrees Celsius. In this embodiment, the temperature of the heater 52 is determined by the controller 40 by using a temperature sensor for sensing the temperature of the inner surface of the heater 52. Once the temperature of the heater 52 reaches 100 degrees Celsius, the power supplied to the heater 50 is continuously adjusted to maintain the temperature of the heater 52 at around 100 degrees Celsius, until a puff is detected, as explained later.

In addition, also in response to the user pressing the button, the controller 40 supplies power from the second power supply 46 to the inductor coil 24 to generate an alternating magnetic field in the chamber and inductively heater the susceptor element 114 to a temperature of around 100 degrees Celsius. Once the temperature of the susceptor element 114 reaches around 100 degrees Celsius, the power supplied to the inductor coil 24 is continuously adjusted to maintain the temperature of the susceptor element 114 at around 100 degrees Celsius, until a puff is detected, as explained later.

The phase during which the heater 52 and the susceptor element 114 are maintained at around 100 degrees Celsius, which is below an aerosolisation temperature required for the aerosol-forming substrate 104 to form an aerosol, is referred to as a maintenance phase. In this embodiment, the aerosolisation temperature of the aerosol-forming substrate 104 is around 170 degrees Celsius. Once both the heater 52 and the susceptor element 114 have reached 100 degrees Celsius, an indicator (not shown) such as a light, speaker, or haptic feedback device, indicates to the user that the device 10 is ready for puffing.

The user then puffs, or inhales, on the mouthpiece 110 of the article 102. This results in an air flow being drawn through the device air inlet 60, through the flow restrictor 64, through the device air outlet 66, then through the article 102, then into the mouth of the user. This air flow path is illustrated by a dashed line in FIG. 2.

The flow restrictor 64 reduces a cross-sectional area of the device air flow path. Thus, as air flows through the flow restrictor 64, the air flow accelerates and reduces in pressure. The pressure in the flow restrictor 64 is sensed by the pressure sensor 66 of the puff detection mechanism and relayed continuously, or at frequent intervals such as every 50 milliseconds, to the controller 40. When the pressure in the flow restrictor reduces by a significant amount, thus indicating a user is puffing on the mouthpiece 110, the maintenance phase ends and a puffing phase begins.

In response to detecting the puff, the controller 40 increases the power supplied to the heater 52 and to the inductor coil 24. Specifically, the controller 40 increases the amplitude of the direct current supplied to the heater 52 and the amplitude of the alternating current supplied to the inductor coil 24. This results in heating the heater 52 to a temperature of around 250 degrees Celsius and heating the susceptor 114 to a temperature of around 250 degrees Celsius. This heats the heating zone in the chamber 16 to around 250 degrees Celsius throughout, and heats the aerosol-forming substrate 104 to above the aerosolisation temperature of the aerosol-forming substrate 104 form an aerosol.

In this embodiment, during the puffing phase, the controller 40 maintains the temperature of the heater 52 at around 250 degrees Celsius. However, during the puffing phase, the controller 40 may adjust the power supplied to the inductor coil 24 based on one or more inputs. For example, inputs from the puff detection mechanism, including the pressure sensor 66, may be used to continuously estimate a flow speed or rate of change of flow speed of the air flow through the device 210 resulting from the puff. In this embodiment, in response to an input from the puff detection mechanism that the flow speed of the air flow through the device 210 has increased above a threshold, the controller 40 increases the supply of power from the second power supply 46 to the inductor coil 24 to heat the susceptor 114 to around 300 degrees Celsius. As the skilled person would understand after reading this disclosure, this is simply one of many ways in which power to the heater or inductor coil could be adjusted during the puffing phase for either of the systems 100, 200 of FIGS. 1 and 2.

As the airflow passes through the aerosol-forming substrate 104 during the puffing phase, as illustrated by the dashed line in FIG. 2, aerosol generated by heating of the aerosol-forming substrate 104 is entrained in the airflow. The aerosol then flows along the length of the article 102 and through the mouthpiece 110 to the user.

When the pressure sensor 66 senses the pressure in the flow restrictor has returned to atmospheric or near atmospheric pressure, this may indicate that the puff has ended. When the controller 40 determines that the puff has ended, the controller 40 ends the puffing phase and returns to the maintenance phase. Thus, the controller 40 adjusts the power supplied to the inductor coil 24 and the heater 52 so as to reach and then maintain the temperatures of the susceptor 114 and the heater 52 at around 100 degrees Celsius.

Similar puffing phases are repeated for each of a plurality of puffs during the usage session. After each puffing phase, there is a maintenance phase. After a number of puffing phases during the usage session, or after a time has lapsed after the first puffing phase of the usage session, the indicator indicates to the user that the usage session is ending. This may coincide with when it's expected that most of the aerosol-forming substrate 104 has been heated sufficiently to form an aerosol, so the aerosol-forming substrate 104 is substantially depleted. The controller 40 then stops supplying power to the heater 52 and the inductor coil 24. The device 210 may then turn off and wait to be re-activated for another usage session.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating device, comprising:
a chamber configured to receive at least a portion of an aerosol-generating article comprising an aerosol-forming substrate;
an electrically resistive heater at least partially surrounding or defining the chamber and configured to provide a heating zone in the chamber; and
an inductor coil at least partially surrounding the electrically resistive heater and configured to generate an alternating magnetic field in the chamber when the inductor coil is supplied with an alternating current.

17. The aerosol-generating device according to claim 16, wherein the electrically resistive heater comprises a tubular electrically insulating substrate and an electrically resistive track on the tubular electrically insulating substrate.

18. The aerosol-generating device according to claim 16, wherein the electrically resistive heater comprises substantially nonferromagnetic materials.

19. The aerosol-generating device according to claim 16, wherein the electrically resistive heater comprises materials having a maximum relative magnetic permeability of no more than 2, and an electrical conductivity of less than 0.8×10⁴ Siemens per metre in at least one direction, at 20 degrees Celsius and a relative humidity of 50%.

20. The aerosol-generating device according to claim 16, wherein the electrically resistive heater is further configured to contact the aerosol-generating article when the aerosol-generating article is at least partially received in the chamber.

21. The aerosol-generating device according to claim 16, wherein the electrically resistive heater comprises one or both of a ceramic material and a polymer composite material.

22. The aerosol-generating device according to claim 16, wherein the inductor coil is wound around the electrically resistive heater.

23. The aerosol-generating device according to claim 16,
further comprising at least one power supply and a controller,
wherein the controller is configured to independently control a supply of power from the at least one power supply to the electrically resistive heater and a supply of power from the at least one power supply to the inductor coil.

24. The aerosol-generating device according to claim 23, wherein during a maintenance phase, the controller is further configured to control the supply of power from the at least one power supply to one or both of the inductor coil and the electrically resistive heater to maintain a temperature of the heating zone within a heating zone maintenance temperature range.

25. The aerosol-generating device according to claim 24, wherein the heating zone maintenance temperature range has an upper limit of no more than 250 degrees Celsius.

26. The aerosol-generating device according to claim 24, wherein the heating zone maintenance temperature range has a lower limit of at least 50 degrees Celsius.

27. The aerosol-generating device according to claim 24, wherein during the maintenance phase, the controller is further configured to control a supply of power from the at least one power supply to the inductor coil to:
supply no power from the at least one power supply to the inductor coil, or maintain a temperature of a susceptor in the chamber within a susceptor maintenance temperature range.

28. The aerosol-generating device according to claim 23, further comprising a puff detection mechanism configured to detect a puff on the aerosol-generating device or the aerosol-generating article received in the chamber and, in response to the puff detection mechanism detecting a puff, the controller is further configured to increase a supply of power from the at least one power supply to the inductor coil.

29. An aerosol-generating system comprising the aerosol-generating device according to claim 16 and the aerosol-generating article configured to be at least partially received in the chamber of the aerosol-generating device.

30. A method of controlling the aerosol-generating device according to claim 16, the method comprising independently controlling a supply of power from the at least one power supply to the electrically resistive heater and a supply of power from the at least one power supply to the inductor coil.
